(19) United States
(12) Patent Application Publication
(10) Pub. No.: US 2025/0247200 A1
(43) Pub. Date: Jul. 31, 2025

(54) REPEATER SYSTEM FOR TRANSMITTING AND RECEIVING SIGNALS BASED ON XDD AND COMMUNICATION SYSTEM USING THE SAME

(71) Applicant: ADRF KOREA, Inc., Icheon-si Gyeonggi-do (KR)

(72) Inventors: Chan Ki CHO, Icheon-si Gyeonggi-do (KR); Hyun Kyung SONG, Gwangju-si Gyeonggi-do (KR); Sung Hyun KIM, Gunpo-si Gyeonggi-do (KR); Baek Yong PARK, Icheon-si Gyeonggi-do (KR)

(73) Assignee: ADRF KOREA, Inc., Icheon-si Gyeonggi-do (KR)

(21) Appl. No.: 18/585,572

(22) Filed: Feb. 23, 2024

(30) Foreign Application Priority Data
Jan. 31, 2024 (KR) 10-2024-0014556

(51) Int. Cl. H04L 5/14; H04L 5/00

(52) U.S. Cl. CPC H04L 5/1469; H04L 5/0091; H04L 5/1423

(57) ABSTRACT

The present disclosure may provide a frequency division method and a structure for a repeater system for supporting XDD in a repeater based on frequency division duplex (FDD). The repeater system includes a donor antenna, a server antenna, and a digital signal processor. The donor antenna is configured to receive a FDD downlink signal from a base transceiver station (BTS), transmit the FDD downlink signal to a first downlink path through a downlink of a donor duplexer, receive a time division duplex (TDD) downlink signal from the BTS, transmit the TDD downlink signal to a second downlink path through an uplink of the donor duplexer, receive a TDD uplink signal that has been output through a first uplink path through the donor duplexer, transmit the TDD uplink signal to the BTS, receive an FDD uplink signal, and transmit the FDD uplink signal to the BTS.

### CROSS-REFERENCE TO RELATED APPLICATION

This application is based on and claims priority under 35 U.S.C. § 119 to Korean patent application number 10-2024-0014556, filed on Jan. 31, 2024, in the Korean Intellectual Property Office, the disclosure of which is incorporated by reference herein in its entirety.

### BACKGROUND

### 1. Technical Field

The present disclosure relates to a repeater system for transmitting or receiving a signal based on cross division duplex (XDD) and a communication method using the same. More specifically, the present disclosure relates to a frequency division method and structure for a repeater system for supporting XDD in a repeater based on frequency division duplex (FDD).

### 2. Related Art

In a wireless communication system, a terminal may receive a downlink signal or transmit an uplink signal based on a resource configuration that has been configured by a base station. Furthermore, a frequency division duplex (FDD) method and a time division duplex (TDD) method may be used as a method of transmitting an uplink signal and a downlink signal between the base station and the terminal.

In a conventional 4G or 5G wireless communication system, FDD or TDD is used for duplex. XDD, that is, a new duplex method, is a technology in which a base station can simultaneously transmit and receive signals by using different frequency resources within a carrier. If XDD is used, an uplink performance limit of the existing TDD system can be overcome, and a coverage improvement or throughput improvement and delay reduction effects can be obtained.

A conventional repeater system requires a new structure for a repeater system for supporting XDD because the conventional repeater system does not support such XDD.

### SUMMARY

Various embodiments are directed to providing a method and repeater system for supporting XDD in a repeater of a 5G or 6G communication system for constructing next-generation wireless infrastructure.

Furthermore, various embodiments are directed to providing a frequency division method for supporting XDD by using a repeater based on an FDD system and a system therefor.

Furthermore, various embodiments are directed to providing a repeater system, which efficiently handles a frequency arrangement and operating method of a base station, enables a change in uplink and downlink communication methods to be efficiently accepted and used, and can perform synchronization, a degree of signal separation, and filtering for the processing of a TDD signal by dividing and configuring the frequency or time of at least one of uplink and downlink.

Furthermore, various embodiments are directed to providing a repeater system based on XDD in a form suitable for a corresponding environment by providing the repeater system in which both uplink and downlink or only any one of the uplink and the downlink has been duplexed.

Objects of the present disclosure are not limited to the aforementioned contents, and the other technical objects not described above may be evidently understood by those skilled in the art from the following description.

In an embodiment, a repeater system for transmitting or receiving a signal based on cross division duplex (XDD) may include a donor antenna configured to receive a frequency division duplex (FDD) downlink signal from a base transceiver station (BTS), transmit the FDD downlink signal to a first downlink path through the downlink of a donor duplexer, receive a time division duplex (TDD) downlink signal from the BTS, transmit the TDD downlink signal to a second downlink path through the uplink of the donor duplexer, receive a TDD uplink signal that has been output through a first uplink path through the donor duplexer, transmit the TDD uplink signal to the BTS, receive an FDD uplink signal that has been output through a second uplink path through the donor duplexer, and transmit the FDD uplink signal to the BTS, a server antenna configured to transmit the FDD downlink signal that has been output through the first downlink path to a terminal, transmit the TDD downlink signal that has been output through the second downlink path to the terminal, receive the TDD uplink signal from the terminal, transmit the TDD uplink signal to the first uplink path through the downlink of a server duplexer, receive the FDD uplink signal from the terminal, and transmit the FDD uplink signal to the second uplink path through the uplink of the server duplexer, and a digital signal processor configured to receive the FDD downlink signal that has been transmitted through the first downlink path, the TDD downlink signal that has been transmitted through the second downlink path, the TDD uplink signal that has been transmitted through the first uplink path, and the FDD uplink signal that has been transmitted through the second uplink path and to perform filtering suitable for a signal bandwidth on each of the FDD downlink signal, the TDD downlink signal, the TDD uplink signal, and the FDD uplink signal.

In this case, input/output stages of the first downlink path, the second downlink path, the first uplink path, and the second uplink path may each further include a path configuration unit configured to change paths of an FDD signal and a TDD signal.

Furthermore, the path configuration unit may include at least one of a circulator, an RF switch, and a relay.

Furthermore, the repeater system may further include a TDD sync signal generator configured to generate a TDD switching signal capable of separating uplink and downlink.

Furthermore, the digital signal processor may be configured to perform a digital pre-distortion function.

In another embodiment of the present disclosure, a repeater system for transmitting or receiving a signal based on cross division duplex (XDD) may include a donor antenna configured to receive a frequency division duplex (FDD) downlink signal from a base transceiver station (BTS), transmit the FDD downlink signal to a downlink path through the downlink of a donor duplexer, receive a time division duplex (TDD) uplink signal that has been output through a first uplink path through the donor duplexer, transmit the TDD uplink signal to the BTS, receive an FDD uplink signal that has been output through a second uplink path through the donor duplexer, and transmit the FDD uplink signal to the BTS, a server antenna configured to transmit the FDD downlink signal that has been output through the downlink path to a terminal, receive the TDD uplink signal from the terminal, transmit the TDD uplink signal to the first uplink path through the downlink of a server duplexer, receive the FDD uplink signal from the terminal, and transmit the FDD uplink signal to the second uplink path through the uplink of the server duplexer, and a digital signal processor configured to receive the FDD downlink signal that has been transmitted through the downlink path, the TDD uplink signal that has been transmitted through the first uplink path, and the FDD uplink signal that has been transmitted through the second uplink path and to perform filtering suitable for a signal bandwidth on each of the FDD downlink signal, the TDD uplink signal, and the FDD uplink signal.

Furthermore, input/output stages of the downlink path and the first uplink path may each include a path configuration unit configured to change paths of an FDD signal and a TDD signal.

In still another embodiment of the present disclosure, a repeater system for transmitting or receiving a signal based on cross division duplex (XDD) may include a donor antenna configured to receive a frequency division duplex (FDD) downlink signal from a base transceiver station (BTS), transmit the FDD downlink signal to a first downlink path through the downlink of a donor duplexer, receive a time division duplex (TDD) downlink signal from the BTS, transmit the TDD downlink signal to a second downlink path through the uplink of the donor duplexer, receive an FDD uplink signal that has been output through an uplink path through the donor duplexer, and transmit the FDD uplink signal to the BTS, a server antenna configured to transmit the FDD downlink signal that has been output through the first downlink path to a terminal, transmit the TDD downlink signal that has been output through the second downlink path to the terminal, receive the FDD uplink signal from the terminal, and transmit the FDD uplink signal to the uplink path through the uplink of a server duplexer, and a digital signal processor configured to receive the FDD downlink signal that has been transmitted through the first downlink path, the TDD downlink signal that has been transmitted through the second downlink path, and the FDD uplink signal that has been transmitted through the uplink path and to perform filtering suitable for a signal bandwidth on each of the FDD downlink signal, the TDD downlink signal, and the FDD uplink signal.

Furthermore, there may be provided the repeater system, further including a path configuration unit configured to change paths of an FDD signal and a TDD signal at each of the input/output stages of the second downlink path and uplink path.

According to an embodiment of the present disclosure, a method and repeater system for supporting XDD in a repeater of a 5G or 6G communication system for constructing next-generation wireless infrastructure can be provided.

Furthermore, according to an embodiment of the present disclosure, a frequency division method for supporting XDD by using a repeater based on an FDD system and a system therefor can be provided.

Furthermore, according to an embodiment of the present disclosure, the repeater system which can efficiently handle a frequency arrangement and operating method of a base station, enables a change in uplink and downlink communication methods to be efficiently accepted and used, and can perform synchronization, a degree of signal separation, and filtering for the processing of a TDD signal by dividing and configuring the frequency or time of at least one of uplink and downlink can be provided.

Furthermore, according to an embodiment of the present disclosure, a repeater system based on XDD can be provided in a form suitable for a corresponding environment by providing the repeater system in which both uplink and downlink or only any one of the uplink and the downlink has been duplexed.

Effects of the present disclosure are not limited to the aforementioned effects, and the other technical effects not described above may be evidently understood by those skilled in the art from the following description.

### BRIEF DESCRIPTION OF THE DRAWINGS

FIG. 1 is a diagram illustrating a construction of a repeater system based on XDD in which downlink and uplink have been duplexed according to an embodiment of the present disclosure.

FIG. 2 is a diagram for describing an operation of a path configuration unit according to an embodiment of the present disclosure.

FIG. 3 is a diagram illustrating a construction of a repeater system based on XDD in which only uplink has been duplexed according to an embodiment of the present disclosure.

FIG. 4 is a diagram illustrating a construction of a repeater system based on XDD in which only downlink has been duplexed according to an embodiment of the present disclosure.

FIGS. 5A and 5B are diagrams illustrating an example in which a frequency or time for supporting an XDD system according to an embodiment of the present disclosure is divided and allocated.

### DETAILED DESCRIPTION

Hereinafter, embodiments of the present disclosure are described in detail with reference to the accompanying drawings so that a person having ordinary knowledge in the art to which the present disclosure pertains easily practice the embodiments. However, the present disclosure may be implemented in other various forms, and is not limited to the embodiments described herein. Furthermore, in order to clarify an embodiment of the present disclosure in the drawings, a part not related to the description is omitted.

Terms used in this specification are used to merely describe a specific embodiment, and are not intended to limit the present disclosure. An expression of the singular number includes an expression of the plural number unless clearly defined otherwise in the context.

In this specification, it is to be understood that a term, such as “include” or “have”, is intended to designate that a characteristic, a number, a step, an operation, a component, a part or a combination of them described in the specification is present, and does not exclude the presence or addition possibility of one or more other characteristics, numbers, steps, operations, components, parts, or combinations of them in advance.

Furthermore, components disclosed in embodiments of the present disclosure have been independently illustrated in order to represent different and characteristic functions. It does not mean that each of the components is formed of separated hardware or one hardware component unit. That is, the components may be arranged and described for convenience of a description, and at least two of the components may be combined to form one component or one component may perform a function by being divided into a plurality of components. An embodiment in which such components have been combined or an embodiment in which such components have been separated from each other is also included in the scope of rights of the present disclosure unless the embodiment does not depart from the essence of the present disclosure.

Hereinafter, embodiments of the present disclosure are described with reference to the accompanying drawings.

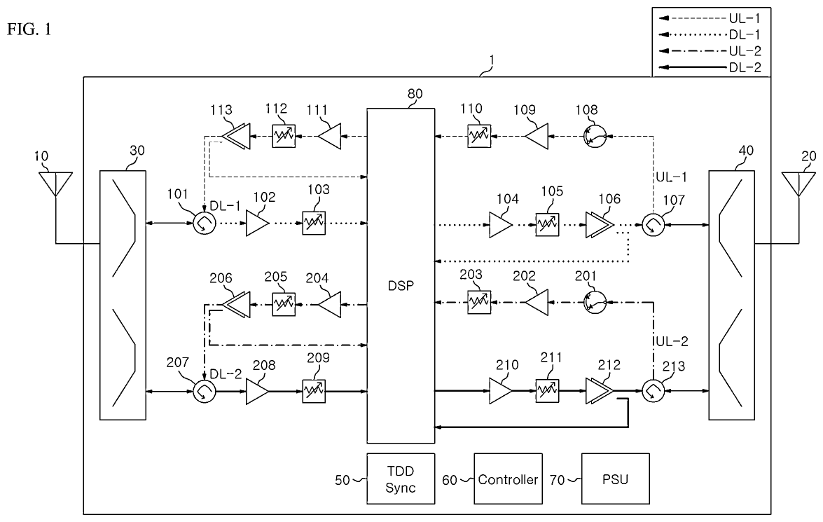

FIG. 1 is a diagram illustrating a construction of a repeater system based on cross division duplex (XDD) in which downlink and uplink have been duplexed according to an embodiment of the present disclosure.

The repeater system of FIG. 1 has a structure that has been changed to process a TDD signal based on an FDD system structure in order to transmit and receive signals based on XDD. FIG. 1 illustrates the construction of the repeater system including, a donor antenna 10, a server antenna 20, and a repeater 1 connected to the donor antenna 10 and the server antenna 20.

First, the donor antenna 10 may be configured to receive an FDD downlink signal from a base transceiver station (BTS), transmit the FDD downlink signal to a first downlink path through the downlink of a donor duplexer 30, receive a TDD downlink signal from the BTS, transmit the TDD downlink signal to a second downlink path through the uplink of the donor duplexer 30, receive a TDD uplink signal that has been output through a first uplink path through the donor duplexer 30, transmit the TDD uplink signal to the BTS, receive an FDD uplink signal that has been output through a second uplink path through the donor duplexer 30, and transmit the FDD uplink signal to the BTS.

Furthermore, the server antenna 20 may be configured to transmit the FDD downlink signal that has been output through the first downlink path to a terminal, transmit the TDD downlink signal that has been output through the second downlink path to the terminal, receive a TDD uplink signal from the terminal, transmit the TDD uplink signal to the first uplink path through the downlink of a server duplexer 40, receive an FDD uplink signal from the terminal, and transmit the FDD uplink signal to the second uplink path through the uplink of the server duplexer 40.

Furthermore, a digital signal processor (DSP) 80 may be configured to receive the FDD downlink signal that has been transmitted through the first downlink path, the TDD downlink signal that has been transmitted through the second downlink path, the TDD uplink signal that has been transmitted through the first uplink path, and the FDD uplink signal that has been transmitted through the second uplink path and to perform filtering on the FDD downlink signal, the TDD downlink signal, the TDD uplink signal, and the FDD uplink signal, based on the signal bandwidth of each of the FDD downlink signal, the TDD downlink signal, the TDD uplink signal, and the FDD uplink signal. Furthermore, the DSP 80 may be configured to perform a digital pre-distortion (DPD) function, and may not selectively use the DPD function depending on signal output efficiency.

Furthermore, path configuration units 101, 107, 207, and 213 are disposed to support both an FDD signal and a TDD signal for the input/output stages of the first downlink path, the second downlink path, the first uplink path, and the second uplink path, and performs a role to change the paths of an FDD signal and a TDD signal. The path configuration units 101, 107, 207, and 213 may be configured to include at least one of a circulator, an RF switch, and a relay.

Hereinafter, the flows of the signals of the first and second downlink paths and the first and second uplink paths in an XDD structure in which both downlink and uplink have been duplexed are separated and specifically described.

### First Downlink Path

An FDD downlink signal that is transmitted by the BTS is input through the donor antenna 10. The input signal is transmitted to the downlink of the donor duplexer 30 of a bandpass filter through which only a downlink signal passes. In this case, the path configuration unit 101 of downlink is used to support both FDD and TDD structures within the downlink. The path configuration unit 101 may use a circulator, may duplex an RF switch in order to simplify the structure of an output signal in a low output product, or may use a device capable of a degree of signal separation, such as a relay similar to the RF switch.

Next, the FDD downlink signal that has passed through the path configuration unit 101 is transmitted to a low noise amplifier (LNA) 102. The FDD downlink signal that has been input to the LNA 102 is transmitted to an attenuator 103 after the FDD downlink signal is amplified and noise of the FDD downlink signal is minimized through the LNA 102. The FDD downlink signal is input to the DSP 80 after the level of the FDD downlink signal is attenuated into a proper signal level suitable for the DSP 80 through the attenuator 103.

The DSP 80 outputs the FDD downlink signal by performing filtering suitable for a signal bandwidth that is used in the FDD downlink signal that has been input through the attenuator 103. The FDD downlink signal that has passed through the DSP 80 is properly amplified and attenuated through an amplifier (AMP) 104 and an attenuator 105, and is amplified through a high power amplifier (HPA) 106. The FDD downlink signal is transmitted to the server duplexer 40 after the FDD downlink signal is separated from a TDD uplink signal or the FDD downlink signal and the TDD uplink signal are combined through the path configuration unit 107. The FDD downlink signal of the server is transmitted to the terminal through the server antenna 20.

### First Uplink Path

A TDD uplink signal for duplex, which is transmitted by the terminal, is transmitted to the uplink of the server duplexer 40 of a bandpass filter through which only an FDD uplink signal passes, through the server antenna 20. In this case, the path configuration unit 107 of uplink is used to support both FDD and TDD structures within the uplink.

A TDD uplink signal of downlink that has passed through the path configuration unit 107 is transmitted to an LNA 109 via a TDD switch (SW) 108 for securing a degree of signal separation. In this case, the TDD SW 108 may consist of an RF switch SW. The TDD uplink signal for duplex is separated as a TDD uplink signal through the path configuration unit 107 of the downlink and is then transmitted to the TDD SW 108. The TDD SW 108 performs high isolation in order to transmit only the TDD uplink signal that has been transmitted within the downlink.

The TDD uplink signal that has been input to the LNA 109 is amplified and transmitted to an attenuator 110 by minimizing noise of the TDD uplink signal. The TDD uplink signal may be input to the DSP 80 after the level of the TDD uplink signal is attenuated into a signal level suitable for the DSP 80 through the attenuator 110.

The DSP 80 outputs the TDD uplink signal by performing filtering suitable for a signal bandwidth that is used in the TDD uplink signal that has been input through the attenuator 110. The DSP 80 is configured to perform filtering that complies with the signal bandwidth and to isolate an FDD signal in order to separate the TDD uplink signal that is input through the attenuator 110 from a downlink signal.

The TDD uplink signal that has passed through the DSP 80 is properly amplified and attenuated through an AMP 111 and an attenuator 112, amplified through an HPA 113, and then transmitted to the donor duplexer 30 after uplink and downlink FDD signals and uplink and downlink TDD signals for duplex are separated or combined through the path configuration unit 101. The TDD uplink signal of the donor is transmitted to the BTS through the donor antenna 10.

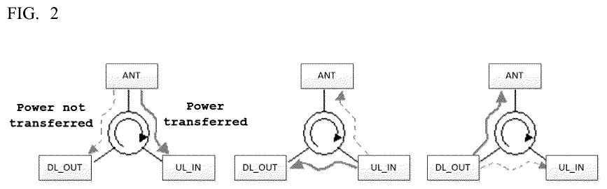

In this case, a function of the path configuration unit 101 is more specifically described with reference to FIG. 2. The path configuration unit 101 has a structure having a very small insertion loss, through which power is transmitted in the direction of a signal that is indicated by a solid line arrow. The path configuration unit 101 has a structure through which power is not transmitted in the direction of a signal that is indicated by a dotted line arrow because isolation occurs. For example, when an uplink (UL) signal or a downlink (DL) signal is transmitted from an antenna port, the signal passes through the antenna port with a small loss. Two different signals may be combined because the two different signals pass through the antenna port as described above. The two different signals may be separated because isolation occurs depending on the direction of another signal and thus power is not transmitted.

### Second Downlink Path

A TDD downlink signal for duplex that is transmitted by the BTS is transmitted to the downlink of the donor duplexer 30 of the bandpass filter through which only an FDD downlink signal passes, through the donor antenna 10. The TDD downlink signal for duplex that has been transmitted to the downlink is separated as a TDD downlink signal through the path configuration unit 207 and is then transmitted to a TDD downlink LNA 208. The TDD downlink signal is low-noise amplified through the TDD downlink LNA 208, transmitted to an attenuator 209, and then input to the DSP 80 after the level of the TDD downlink signal is attenuated into a proper signal level that is necessary for the DSP 80.

The DSP 80 may be configured to perform filtering that complies with a signal bandwidth and to isolate an FDD uplink signal in order to separate the TDD downlink signal that has been input through the attenuator 209 from an uplink signal.

The TDD downlink signal that has passed through the DSP 80 is properly amplified and attenuated through an AMP 210 and an attenuator 211, and is then amplified through an HPA 212. A power AMP is linearized by improving efficiency of the AMP through digital pre-distortion (DPD), and FDD uplink and downlink signals and TDD uplink and downlink signals for duplex are separated and combined through the path configuration unit 213. Thereafter, the TDD downlink signal is transmitted to the server duplexer 40. The TDD downlink signal of the server is transmitted to the terminal through the server antenna 20.

### Second Uplink Path

An FDD uplink signal that is transmitted by the terminal is transmitted to the uplink of the server duplexer 40 of the bandpass filter through which only an FDD uplink signal passes, through the server antenna 20. The path configuration unit 213 of uplink is used to support both FDD and TDD signal structures within the uplink.

The FDD uplink signal of the uplink that has passed through the path configuration unit 213 is transmitted to an LNA 202 via a TDD SW 201 for securing a degree of signal separation. The FDD uplink signal that has been input to the LNA 202 is transmitted to an attenuator 203 after the FDD uplink signal is amplified and noise of the FDD uplink signal is minimized. The FDD uplink signal is input to the DSP 80 after the level of the FDD uplink signal is attenuated into a signal level suitable for the DSP 80 through the attenuator 203. The DSP 80 outputs the FDD uplink signal by performing filtering suitable for a signal bandwidth that is used in the FDD uplink signal that has been input through the attenuator 203.

The FDD uplink signal that has passed through the DSP 80 is properly amplified and attenuated through an AMP 204 and an attenuator 205 and is then amplified through an HPA 206. A power AMP is linearized by improving efficiency of the AMP through digital pre-distortion (DPD), and FDD uplink and downlink signals and TDD uplink and downlink signals for duplex are separated and combined through the path configuration unit 207. Thereafter, the FDD uplink signal is transmitted to the donor duplexer 30. The FDD uplink signal of the donor is transmitted to the BTS through the donor antenna 10.

Furthermore, a TDD sync signal generator 50 may be configured to generate a TDD switching signal capable of separating uplink and downlink. The TDD switching signal may be controlled through a signal controller 60. The TDD sync signal generator 50 and the signal controller 60 may be implemented in the form of a module in which the TDD sync signal generator 50 and the signal controller 60 have been integrated with the DSP 80. For example, the TDD sync signal generator 50 may control the TDD SW 108 through the signal controller 60 by receiving a TDD signal and outputting a TDD switching signal. The TDD sync signal generator 50 may control the TDD switching signal through the signal controller 60 in order to control the TDD SW 108 although a TDD signal is not present.

Furthermore, a power supply unit (PSU) 70 is a device for supplying power to equipment, and may be constructed by being changed in a form in which the PSU is supplied with power through an UTP cable or may be constructed in a form in which the PSU is supplied with power through a feel power line (or a power cable), for example.

As described above, according to the repeater system based on XDD in which downlink and uplink have been duplexed, which has been illustrated in FIG. 1, a multiple-input multiple-output (MIMO) effect can be obtained even without using a MIMO structure.

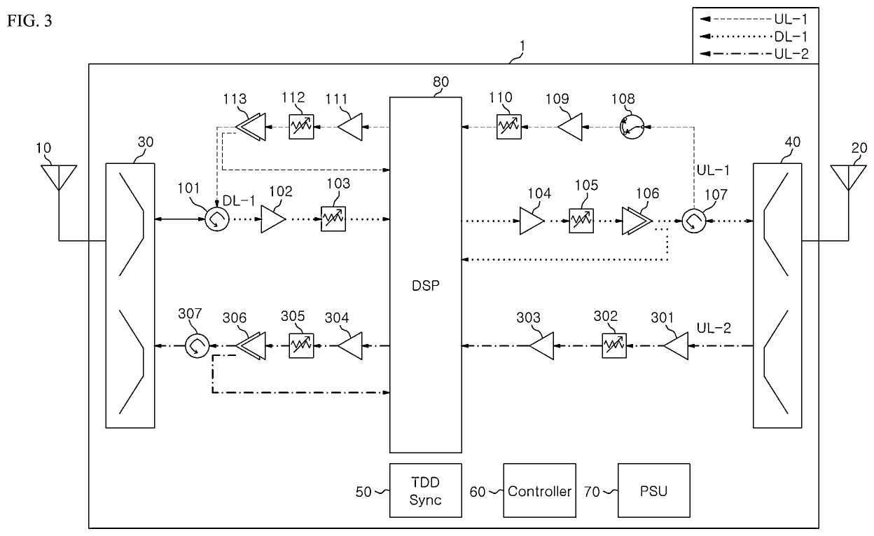

FIG. 3 is a diagram illustrating a construction of a repeater system based on XDD in which only uplink has been duplexed according to an embodiment of the present disclosure.

The repeater system illustrated in FIG. 3 adopts a method of duplexing and using only uplink, and has a structure which is suitably used in an environment in which a wide uplink bandwidth is required in a large-size factory or industrial facility.

Referring to FIG. 3, a donor antenna 10 may be configured to receive an FDD downlink signal from a BTS, transmit the FDD downlink signal to a first downlink path through the downlink of a donor duplexer 30, receive a TDD uplink signal that has been output through a first uplink path through the donor duplexer 30, transmit the TDD uplink signal to the BTS, receive an FDD uplink signal that has been output through a second uplink path through the donor duplexer 30, and transmit the FDD uplink signal to the BTS.

A server antenna 20 may be configured to transmit the FDD downlink signal that has been output through the first downlink path (one downlink path is present) to a terminal, receive a TDD uplink signal from the terminal, transmit the TDD uplink signal to the first uplink path through the up and downlink of a server duplexer 40, receive an FDD uplink signal from the terminal, and transmit the FDD uplink signal to the second uplink path through the uplink of the server duplexer 40.

Furthermore, a DSP 80 may be configured to receive the FDD downlink signal that has been transmitted through the first downlink path, the TDD uplink signal that has been transmitted through the first uplink path, and the FDD uplink signal that has been transmitted through the second uplink path and to perform filtering suitable for a signal bandwidth on each of the FDD downlink signal, the TDD uplink signal, and the FDD uplink signal.

The input/output stages of the first downlink path and the first uplink path may include path configuration units 101 and 107 each configured to change the paths of an FDD signal and a TDD signal.

Furthermore, the constructions of the first downlink path and the first uplink path are the same as those of the system illustrated in FIG. 1, and thus a description thereof is omitted. Through the second uplink path, the FDD uplink signal that has been transmitted through the uplink of the server duplexer 40 is input to an LNA 301, transmitted to an attenuator 302 after the FDD uplink signal is amplified and noise of the FDD uplink signal is minimized, and then input to the DSP 80 after the level of the FDD uplink signal is attenuated into a signal level suitable for the DSP 80 through an AMP 303. The FDD uplink signal that has passed through the DSP 80 is amplified through an AMP 304. The intensity of the FDD uplink signal is adjusted through an attenuator 305. Thereafter, the FDD uplink signal may be amplified through an HPA 306, isolated through an isolator 307, and transmitted to the donor duplexer 30. In this case, the isolator 307 is used to transmit a signal only in one direction and to prevent a signal from being received in an opposite direction.

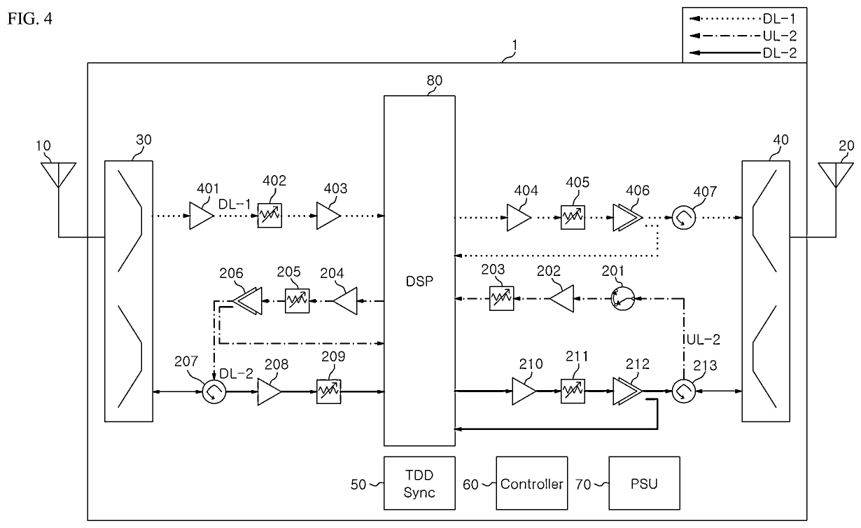

FIG. 4 is a diagram illustrating a construction of a repeater system based on XDD in which only downlink has been duplexed according to an embodiment of the present disclosure.

The repeater system illustrated in FIG. 4 has a structure which may be suitably used in an environment, such as stadiums or theaters in which subscribers are suddenly increased or decreased, by duplexing only downlink.

Referring to FIG. 4, a donor antenna 10 may be configured to receive an FDD downlink signal from a BTS, transmit the FDD downlink signal to a first downlink path through the downlink of a donor duplexer 30, receive a TDD downlink signal from the BTS, transmit the TDD downlink signal to a second downlink path through a second uplink and downlink (only one uplink path is present) of the donor duplexer 30, receive an FDD uplink signal that has been output through an uplink path through the donor duplexer 30, and transmit the FDD uplink signal to the BTS.

A server antenna 20 may be configured to transmit the FDD downlink signal that has been output through the first downlink path to a terminal, transmit the TDD downlink signal that has been output through the second downlink path to the terminal, receive an FDD uplink signal from the terminal, and transmit the FDD uplink signal to the uplink path through the uplink of a server duplexer 40.

A DSP 80 may be configured to receive the FDD downlink signal that has been transmitted through the first downlink path, the TDD downlink signal that has been transmitted through the second downlink path, and the FDD uplink signal that has been transmitted through the uplink path and to perform filtering suitable for a signal bandwidth on each of the FDD downlink signal, the TDD downlink signal, and the FDD uplink signal.

Furthermore, the input/output stages of the second downlink path and the first uplink path may each include a path configuration unit configured to change the paths of an FDD signal and a TDD signal.

In addition, the constructions of the second downlink path and the second uplink path are the same as those of the system illustrated in FIG. 1. The first downlink path including an LNA 401, an attenuator 402, an AMP 403, an AMP 404, an attenuator 405, an HPA 406, an isolator 407 of the first downlink path has the same components as the second uplink path illustrated in FIG. 3, and thus a description thereof is omitted.

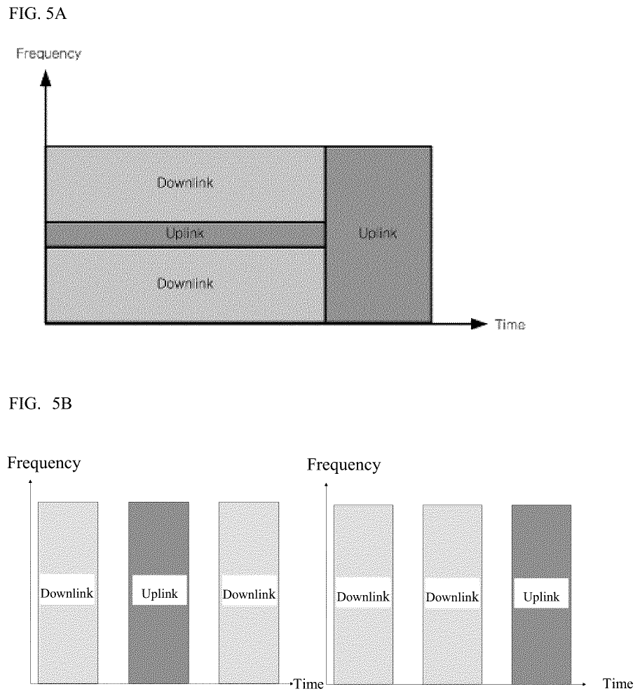

FIGS. 5A and 5B are diagrams illustrating an example in which a frequency or time for supporting an XDD system according to an embodiment of the present disclosure is divided and allocated.

Referring to FIG. 5A, downlink and uplink are used through frequency separation, and the uplink is used in a TDD band in a specific time domain. Accordingly, the uplink performance limit of the existing TDD system can be overcome and uplink coverage can be improved because accumulated energy in uplink is increased. Furthermore, an asymmetrical downlink/uplink traffic problem can be efficiently solved because downlink resources and uplink resources are separated and used even in a time domain in addition to a frequency domain as described above.

Furthermore, referring to FIG. 5B, downlink and uplink may be separately used by allocating part of an FDD band signal to a TDD band, and the ratio of the downlink and the uplink may be adjusted if necessary.

The present disclosure has been described above based on the embodiments illustrated in the accompanying drawings, but the embodiments are merely illustrative. A person having ordinary knowledge in the art to which the present disclosure pertains will understand that various modifications and other equivalent embodiments are possible from the embodiments. Accordingly, the technical range of protection of the present disclosure should be determined by the claims.

What is claimed is:

1. A repeater system for transmitting or receiving a signal based on cross division duplex (XDD), comprising:
a donor antenna configured to receive a frequency division duplex (FDD) downlink signal from a base transceiver station (BTS), transmit the FDD downlink signal to a first downlink path through a downlink of a donor duplexer, receive a time division duplex (TDD) downlink signal from the BTS, transmit the TDD downlink signal to a second downlink path through an uplink of the donor duplexer, receive a TDD uplink signal that has been output through a first uplink path through the donor duplexer, transmit the TDD uplink signal to the BTS, receive an FDD uplink signal that has been output through a second uplink path through the donor duplexer, and transmit the FDD uplink signal to the BTS;
a server antenna configured to transmit the FDD downlink signal that has been output through the first downlink path to a terminal, transmit the TDD downlink signal that has been output through the second downlink path to the terminal, receive the TDD uplink signal from the terminal, transmit the TDD uplink signal to the first uplink path through a downlink of a server duplexer, receive the FDD uplink signal from the terminal, and transmit the FDD uplink signal to the second uplink path through an uplink of the server duplexer; and
a digital signal processor configured to receive the FDD downlink signal that has been transmitted through the first downlink path, the TDD downlink signal that has been transmitted through the second downlink path, the TDD uplink signal that has been transmitted through the first uplink path, and the FDD uplink signal that has been transmitted through the second uplink path and to perform filtering suitable for a signal bandwidth on each of the FDD downlink signal, the TDD downlink signal, the TDD uplink signal, and the FDD uplink signal.

2. The repeater system of claim 1, wherein input/output stages of the first downlink path, the second downlink path, the first uplink path, and the second uplink path each further comprise a path configuration unit configured to change paths of an FDD signal and a TDD signal.

3. The repeater system of claim 2, wherein the path configuration unit comprises at least one of a circulator, an RF switch, and a relay.

4. The repeater system of claim 1, further comprising a TDD sync signal generator configured to generate a TDD switching signal capable of separating uplink and downlink.

5. The repeater system of claim 1, wherein the digital signal processor is configured to perform a digital pre-distortion function.

6. A repeater system for transmitting or receiving a signal based on cross division duplex (XDD), comprising:
a donor antenna configured to receive a frequency division duplex (FDD) downlink signal from a base transceiver station (BTS), transmit the FDD downlink signal to a downlink path through a downlink of a donor duplexer, receive a time division duplex (TDD) uplink signal that has been output through a first uplink path through the donor duplexer, transmit the TDD uplink signal to the BTS, receive an FDD uplink signal that has been output through a second uplink path through the donor duplexer, and transmit the FDD uplink signal to the BTS;
a server antenna configured to transmit the FDD downlink signal that has been output through the downlink path to a terminal, receive the TDD uplink signal from the terminal, transmit the TDD uplink signal to the first uplink path through a downlink of a server duplexer, receive the FDD uplink signal from the terminal, and transmit the FDD uplink signal to the second uplink path through an uplink of the server duplexer; and
a digital signal processor configured to receive the FDD downlink signal that has been transmitted through the downlink path, the TDD uplink signal that has been transmitted through the first uplink path, and the FDD uplink signal that has been transmitted through the second uplink path and to perform filtering suitable for a signal bandwidth on each of the FDD downlink signal, the TDD uplink signal, and the FDD uplink signal.

7. The repeater system of claim 6, wherein input/output stages of the downlink path and the first uplink path each comprise a path configuration unit configured to change paths of an FDD signal and a TDD signal.

8. A repeater system for transmitting or receiving a signal based on cross division duplex (XDD), comprising:
a donor antenna configured to receive a frequency division duplex (FDD) downlink signal from a base transceiver station (BTS), transmit the FDD downlink signal to a first downlink path through a downlink of a donor duplexer, receive a time division duplex (TDD) downlink signal from the BTS, transmit the TDD downlink signal to a second downlink path through an uplink of the donor duplexer, receive an FDD uplink signal that has been output through an uplink path through the donor duplexer, and transmit the FDD uplink signal to the BTS;
a server antenna configured to transmit the FDD downlink signal that has been output through the first downlink path to a terminal, transmit the TDD downlink signal that has been output through the second downlink path to the terminal, receive the FDD uplink signal from the terminal, and transmit the FDD uplink signal to the uplink path through an uplink of a server duplexer; and
a digital signal processor configured to receive the FDD downlink signal that has been transmitted through the first downlink path, the TDD downlink signal that has been transmitted through the second downlink path, and the FDD uplink signal that has been transmitted through the uplink path and to perform filtering suitable for a signal bandwidth on each of the FDD downlink signal, the TDD downlink signal, and the FDD uplink signal.

9. The repeater system of 41 8, wherein claim input/output stages of the second downlink path and uplink path each comprise a path configuration unit configured to change paths of an FDD signal and a TDD signal.
